(19) United States
(12) Patent Application Publication
(10) Pub. No.: US 2009/0199975 A1
(43) Pub. Date: Aug. 13, 2009

(54) ELECTRIC ROMAN SHADE

(76) Inventor: Wei-Cheng YEH, Gangshan Township (TW)

Correspondence Address: Dr. BANGER SHIA, 102 Lindencrest Ct., Sugar Land, TX, 77479-5201, US

(21) Appl. No.: 12/028,342

(22) Filed: Feb. 8, 2008

(51) Int. Cl. E06B 9/68; A47H 5/00

(52) U.S. Cl. 160/84.02; 160/310

(57) ABSTRACT

The present invention pertains to an electric roman shade mainly utilizing the controller to rotate the power motor and the roller bar, thus motivating the covering sheet upward and downward. Additionally, by means of the revolving shaft having threads disposed thereon, the cord thus sequentially wraps the shaft without overlapping thereby steadily adjusting movements of the sheet. Further, the covering sheet would automatically stop working while the sliding sections touching the switching tabs, and users can also rise and descend the sheet at desired positions, thus increasing the convenience of using.

### BACKGROUND OF THE INVENTION

1. Field of the Invention

The present invention relates to a window covering design, in particular to an electric roman shade.

2. Description of the Related Art

Referring to FIG. 1, a conventional roman shade 1 comprises a head rail 11, a pleated sheet 12 with one end affixed to the rail 11 and a transmission device 13 for driving the sheet 12; wherein, the rail 11 has an inner space 111 therein and an interlocking surface 14 secured to the front side thereof (as shown in FIG. 2), further a loop and hook strip 121 is attached to the upper edge of the sheet 12 for being adhesive to the interlocking surface 14. Additionally, the transmission device 13 consists of a roller bar 131 located in the space 111, a rolling pulley 133 attached to the bar 131, a cord control 132 arranged round the pulley 133, and a plurality of cord spools 16 equidistantly spaced on the bar 131, each of which further comprises a base 161 fastened to the bar 11, a rolling shaft 162 on the base 161, and a cord 163 wrapped the shaft 162 having one end thereof attached to the sheet 12.

While in manipulation, users need to pull the cord control 132 to rotate the pulley 133 and the bar 131, and simultaneously the shaft 162 becomes revolving as well to descend or lift the sheet 12 by freeing or retracting the cord 163. Nevertheless, the conventional shade 1 requires a manual operation and probably results in the interruption of the spools 16 if imparting an uneven pulling to cord control 43, thus it is inconvenient. By means of the shaft 162 of the spool 16 having a smooth surface, the cord 163 readily become overlapped while furling the sheet 12, which in turn affects the output thereof in time of freeing cord 163 and the sheet 12 may not have its pendent edge to present in a uniform length, thus still needs improvements.

### SUMMARY OF THE INVENTION

Therefore, the object of the present invention is to provide an electric roman shade which sequentially and steadily transports cord without imparting a manual force so as to increase convenience of using and retain a tidy appearance of the sheet.

The electric roman shade in accordance with the present invention mainly provides with a head rail, a covering sheet, a transmission apparatus and a controlling mechanism. Particularly, the transmission apparatus has a roller bar in the rail, a power motor disposed thereon for driving the bar and cord spools periodically spaced on the bar; each cord spool has a revolving shaft with threads thereon and a cord convolved thereon, thereby steadily and smoothly outputting the cord to descend or lift the covering sheet. Furthermore, the controlling mechanism, which comprises a receiver, a controller attached thereto, and a limiter electrically engaged to the controller, assists to automatically motivate the motor and the bar and then rotate the cord spool in order to prevent the conventional manual method and efficiently increase the using convenience.

The advantages of the present invention over the known prior arts will become more apparent to those of ordinary skilled in the art by reading the following descriptions with the relating drawings.

### BRIEF DESCRIPTION OF THE DRAWINGS

FIG. 1 is a schematic view showing a conventional invention;

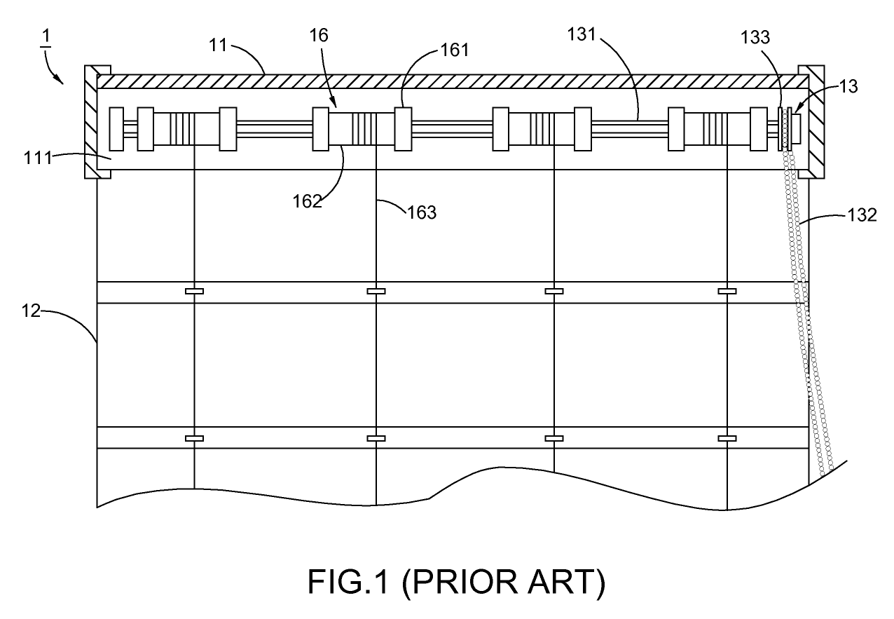

FIG. 2 is a side perspective view showing the conventional invention;

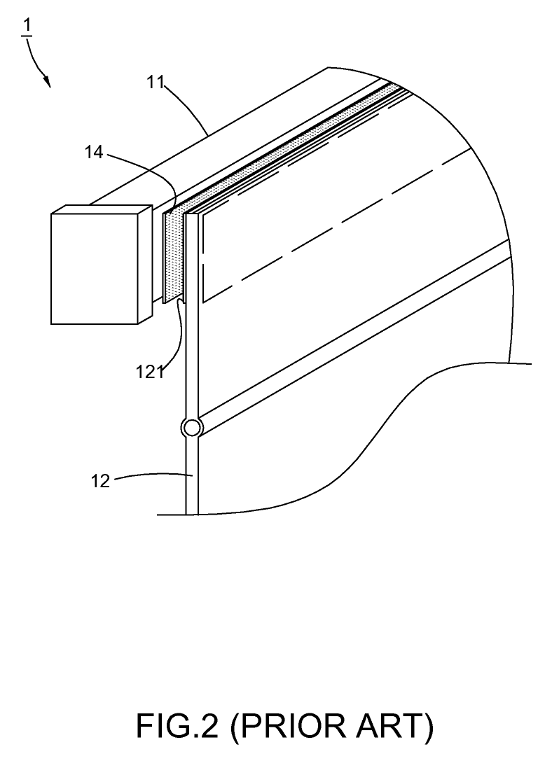

FIG. 3 is an exploded view showing a first preferred embodiment of the present invention;

FIG. 4 is a schematic view showing the first embodiment of the present invention;

FIG. 5 is a partial enlarged view showing the elements of the first embodiment;

FIG. 6 is a schematic view showing the first embodiment of the present invention in time of operating;

FIG. 7 is a schematic view showing a second preferred embodiment of the present invention;

FIG. 8 is an exploded view showing a third preferred embodiment of the present invention; and

FIG. 9 is a schematic view showing the concatenation of elements of FIG. 8.

### DETAILED DESCRIPTION OF THE PREFERRED EMBODIMENTS

Before describing in greater detail, it should note that the like elements are denoted by the similar reference numerals throughout the disclosure.

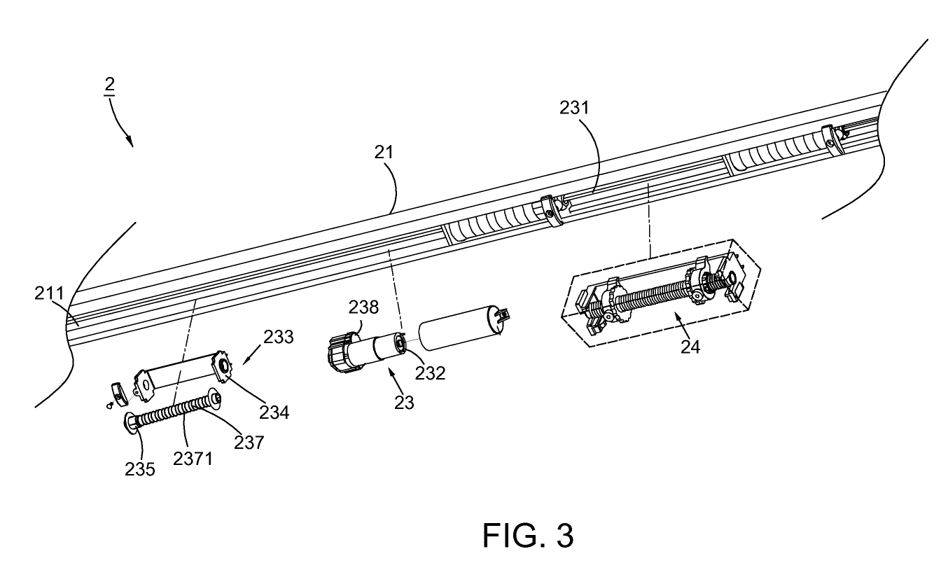

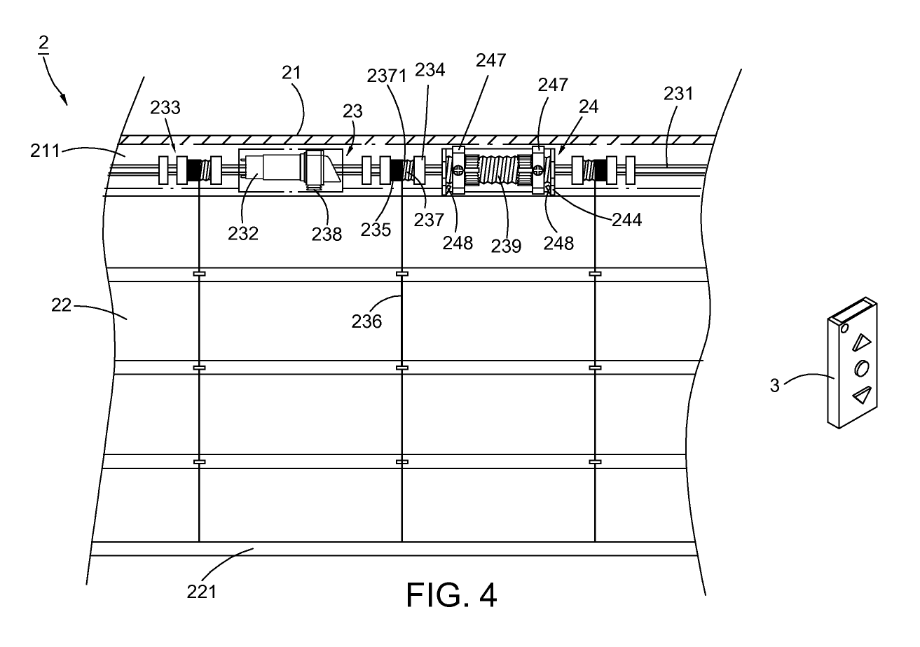

Referring to FIGS. 3 and 4, an electric roman shade 2 of the first preferred embodiment is comprised of a head rail 21, a covering sheet 22 secured to the rail 21, a transmission apparatus 23 disposed inside the rail 21 and a controlling mechanism 24 for driving the transmission apparatus 23; wherein, the head rail 21 has an inner space 211 therein, and the covering sheet 22 with one end thereof is fastened to the rail 21 and a bottom rail 221 is formed at the other end thereof.

Continuing with the aforementioned, the transmission apparatus 23 includes a roller bar 231 mounted in the inner space 211, a power motor 232 secured to the bar 231 and more than one cord spool 233 equidistantly spaced on the bar 231; wherein, a planetary gear assembly 238 (more definitely shown in FIG. 4) is located between the power motor 232 and the roller bar 231 for reinforcing a dynamic force of the power motor 232 to rotate the roller bar 231; each cord spool 233 further consists of a cord body 234 disposed said head rail 21, a revolving shaft 235 mounted on the cord body 234, and a cord 236 spiraled round the revolving shaft 235 and attached its end to the bottom rail 221; the revolving shaft 235 further provides with a plurality of threads 237 disposed thereon and a concave track 2371 arranged between each two threads 237 for permitting the cord 236 convoluted along the track 2371 while rotating the shaft 235.

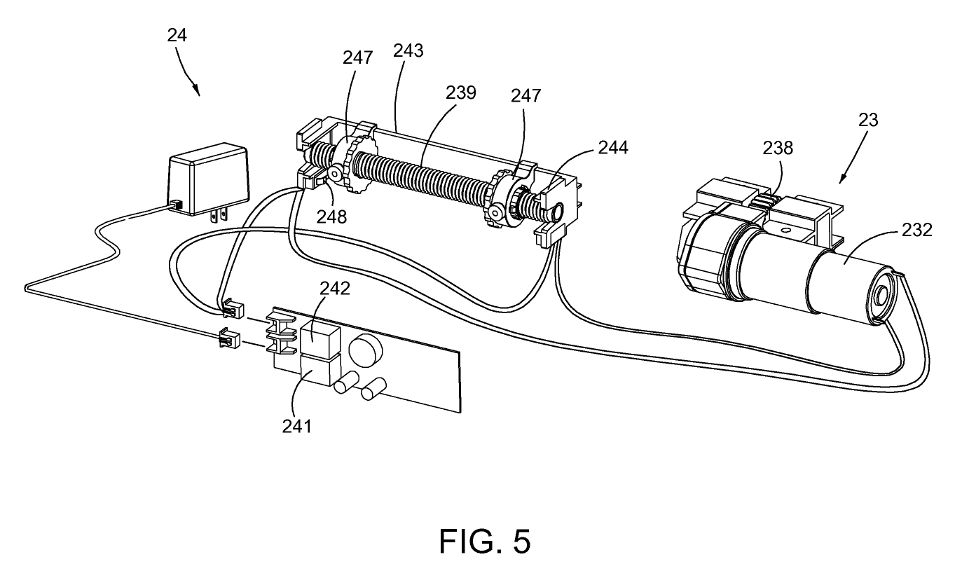

Referring to FIG. 4 and 5, the controlling mechanism 24 further comprises a receiver 241 to receipt signals, a controller 242 attached to the receiver 241 and a limiter 243 electrically engaged to the controller 242; wherein, the singles emitted through a remote controller 3 is received by the receiver 241 and further transmitted to the controller 242; the limiter 243 provides with a shield base 244 disposed within the inner space 211, a threaded shank 239 mounted to the base 244 and contacted to the roller bar 231, dual switching tabs 248 separately disposed on two sides of the base 244 and two sliding sections 247 respectively pivoted to the threaded shank 239. Additionally, the switching tabs 248 can be designed in an electronic induction or an automatic pressing forms, and the pressing tabs are adopted in the embodiments; the switching tabs 248 connect to the controller 242 by circuits and simultaneously attach to the power motor 232 thereby, so that the controller 242 could communicate with the power motor 232 in order to drive it rotating(shown in FIG. 5); furthermore, the covering sheet 22 would automatically stop working until the sliding sections 247 hits one of the tabs 248.

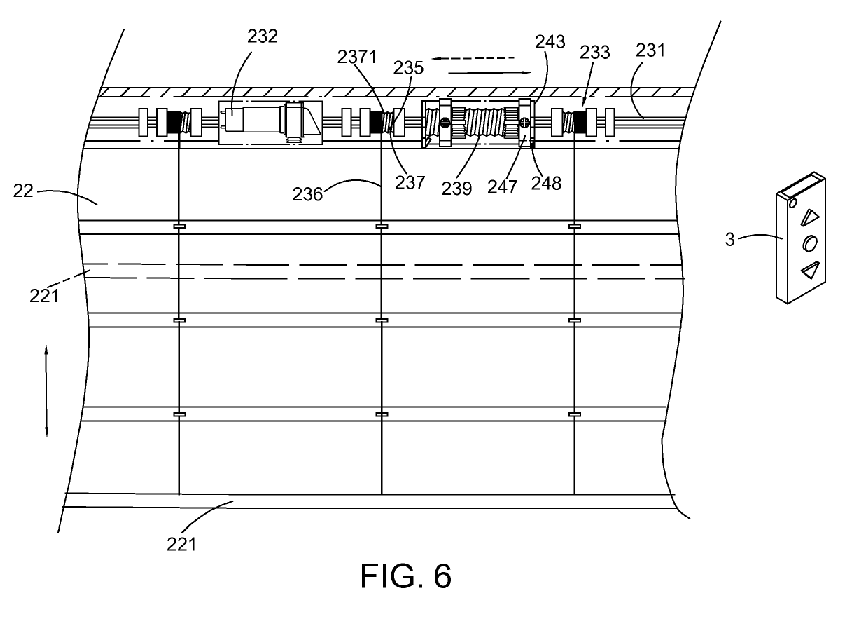

Further referring to FIG. 5 and 6, in operation, users initially press the remote controller 3 to send signals to the receiver 241 and thereafter the receiver 241 transmits them to the controller 242, the power motor 232 thus is driven and enhances its dynamic force through the planetary gear assembly 238 to synchronously revolve the roller bar 231 and the cord spool 233, so as to free the cord 236 and smoothly descend the covering sheet 22 as well. By means of the threads 237 disposed on the revolving shaft 235, the cord 236 begins to regularly deviate from the cord spool 233 along the concave track 2371, thereby descending the covering sheet 22. Simultaneously, the limiter 243 is also driven by the power motor 232, namely the threaded shank 239 is also rotated by the roller bar 231 and renders the sliding sections 247 traveling thereon toward a direction (arrowed in the solid line in FIG. 6), and thereafter the power motor 232 automatically stops working and the covering sheet 22 stops as well at the predetermined position until one of the sliding sections 247 touches its adjacent switching tab 248, whereby the bottom rail 221 keeps a uniform length of its pendent edge and achieves a window blind advantage and. Deservedly, the remote controller 3 can directly suspend the covering sheet 22 at desired positions.

Reciprocally, when the remote controller 3 drives the controller 242 and the power motor 232 to lift the covering sheet 22, the sliding sections 247 remove toward another direction ( as arrowed in dotted line) and simultaneously the cord 236 in turn convolutes the revolving shaft 235 along the concave track 2371 to avoid the overlapping thereof, thereby steadily furling the cord 236 and raising the bottom rail 221 upward to its desired position or automatically stopping it until the sliding sections 247 touch the reverse switching tab 248.

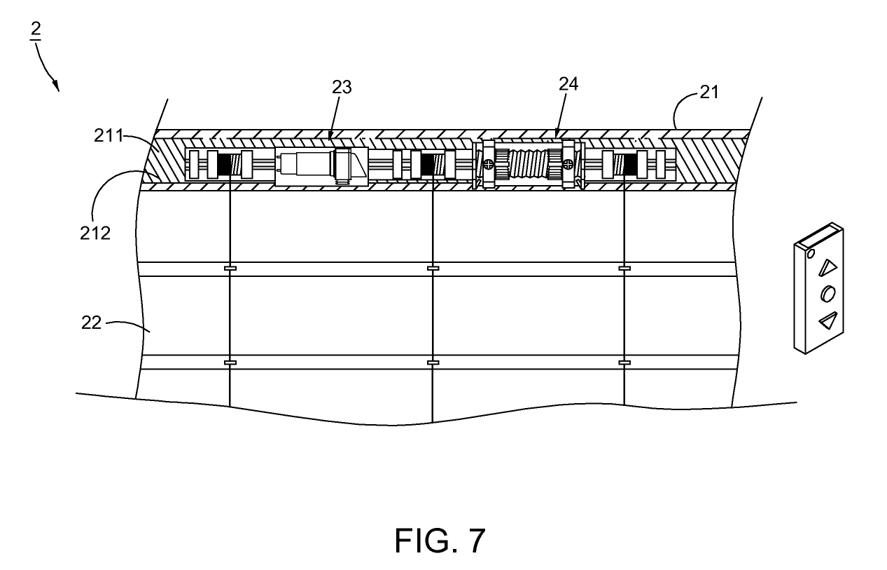

Referring to FIG. 7, a second preferred embodiment of the present invention comprises the similar elements, operations and functions to the first preferred embodiment. Differentially, a certain amount of noise abatement cotton 212 fills the inner space 211, and the cotton 212 wraps the transmission apparatus 23 so as to reduce the noise generated therefrom in operation.

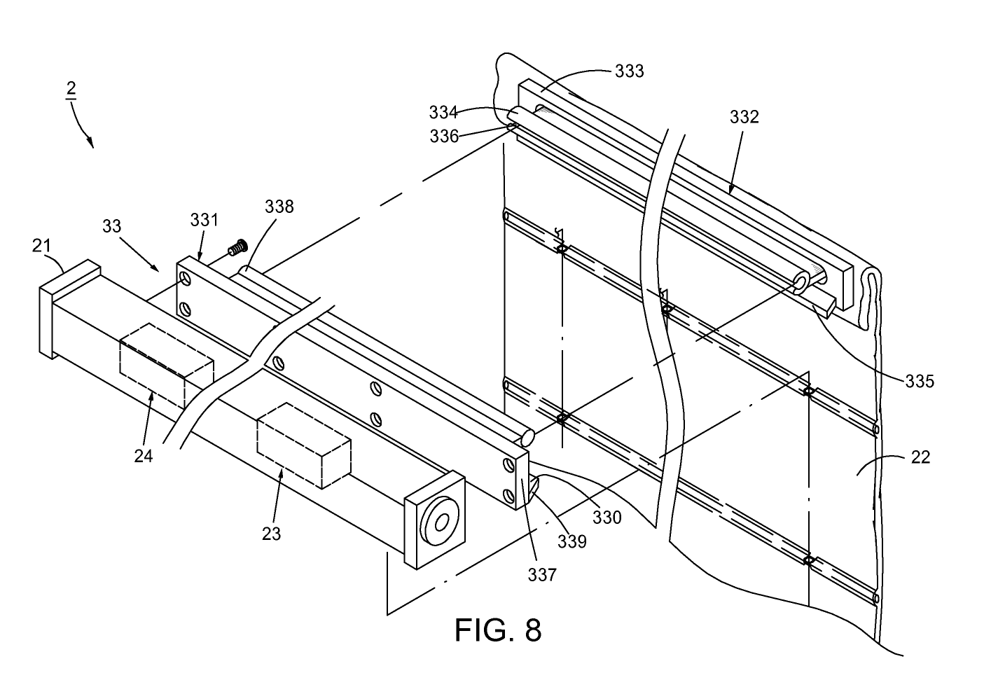

Referring to FIG. 8, a third preferred embodiment of the present invention is still comprised of the similar elements to the first embodiment. Particularly, an attachable mechanism 33 located between the head rail 21 and the covering sheet 22 comprises a folding assembly 331 fastened to the head rail 21 and a housing assembly 332 attached to the covering sheet 22; wherein, the folding assembly 331 has a plate 337, a rod 338 attached to the plate 337 and a beveled bracket 339 protruding from the plate 337; the housing assembly 332 has a housing body 333, a socket 334 affixed to the housing body 333 and a beveled plate 335 below the socket 334 protruding from the housing body 333. Further, the beveled bracket 339 and the plate 337 intersects to form a free space 330, where the beveled plate 335 can enter, and the socket 334, for instance formed of a C-shape, further defines an interior 336 therein for receiving the rod 338.

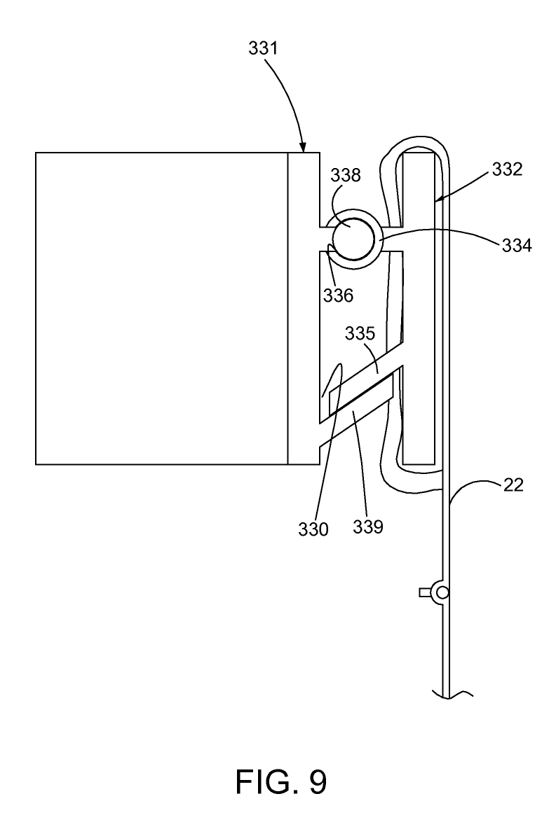

Referring to FIG. 9, while installing, the folding assembly 331 is initially fastened to the head rail 21 by screws. Subsequently, the beveled plate 335 is inserted into the free space 330 and further the rod 338 is snapped into the interior 336 of the socket 334, which results of the beveled bracket 339 being located below the beveled plate 335 for a sustaining advantage so that the housing assembly 332 can firmly attach to the folding assembly 331.

To sum up, the present invention takes advantages of the controlling mechanism which directly drives the power motor and automatically controls the movements of the covering sheet at desired positions so as to manipulate without imparting a manual force, and further the threads of the revolving shaft prevents the cord from being irregularly convoluted on the shaft and facilitates to steadily free or furl the cord, thus efficiently increasing the convenience and obtaining a good appearance of the sheet.

While we have shown and described the embodiment in accordance with the present invention, it should be clear to those skilled in the art that further embodiments may be made without departing from the scope of the present invention.

I claim:

1. An electric roman shade comprising:
a head rail; wherein, said head rail having an inner space therein;
a covering sheet, having one end thereof secured to said head rail and a bottom rail disposed at the other end thereof;
a transmission apparatus for rising and descending said covering sheet; wherein, said transmission apparatus including a roller bar mounted in said inner space, a power motor disposed thereon for driving said bar and more than one cord spool equidistantly spaced on said bar; said cord spool further consisting of a cord body disposed in said head rail, a revolving shaft mounted on said cord body and a cord convolved said revolving shaft and attached its end to said bottom rail for driving said covering sheet upward and downward; said revolving shaft having a plurality of threads disposed thereon and a concave track arranged between each two threads for permitting said cord spiraled therebetween; and
a controlling mechanism for driving said transmission apparatus, comprising a receiver to receipt signals, a controller attached to said receiver and a limiter electrically engaged to said controller; wherein, said singles received by said receiver being transmitted to said controller for driving said power motor; said limiter further providing with a shield base disposed within said inner space, a threaded shank mounted to said base and contacted to said roller bar, dual switching tabs separately disposed on two sides of said base and at least one sliding section pivoted to said threaded shank; said switching tabs connecting to said controller so as to automatically stop movements of said covering sheet by said sliding section hitting said tabs.

2. The electric roman shade as claimed in claim 1, wherein, a certain amount of noise abatement cotton fills said inner space.

3. The electric roman shade as claimed in claim 1, wherein, a planetary gear assembly is disposed between said power motor and said roller bar, thereby reinforcing a dynamic force of said power motor to rotate said roller bar.

4. The electric roman shade as claimed in claim 1, wherein, said limiter is preferably comprised of two sliding sections.

5. The electric roman shade as claimed in claim 1, wherein, an attachable mechanism located between said head rail and said covering sheet comprises a folding assembly fastened to said head rail and a housing assembly attached to said covering sheet; wherein, said folding assembly has a plate, a rod attached to said plate and a beveled bracket protruding from said plate; said housing assembly has a housing body, a socket disposed on said housing body and a beveled plate below said socket protruding from said housing body; said beveled bracket and said plate intersects to form a free space, where said beveled plate can enter, and said socket further defines an interior therein for receiving said rod.
